(19) United States
(12) Patent Application Publication
(10) Pub. No.: US 2007/0275715 A1
(43) Pub. Date: Nov. 29, 2007

(54) Home network system and method for remotely installing home services in the same

(76) Inventors: Il Woo Lee, Daejeon (KR); Ho Jin Park, Daejeon (KR); Chan Mi Jung, Daejeon (KR); Sang Ha Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/603,494

(22) Filed: Nov. 22, 2006

(30) Foreign Application Priority Data
May 24, 2006 (KR) 10-2006-0046753

(51) Int. Cl. H04Q 7/20

(52) U.S. Cl. 455/427

(57) ABSTRACT

A home network system and a method for installing home services in the home network system are provided. The home network system includes a service distribution management system that remotely manages a plurality of home gateways installed in homes of service users and services installed on the plurality of home gateways. The method includes performing user registration of a service user who desires to receive a service, registering a service to be provided to the service user, performing initial registration of a home gateway which a system manager has installed in a home of the service user according to the user registration, managing at least one home gateway group set by the system manager, and performing management of a task for remotely installing a service on a home gateway group that is an installation target of the service.

### RELATED APPLICATION

The present application is based on, and claims priority from, Korean Application Number 2006-46753, filed May 24, 2006, the disclosure of which is incorporated by reference herein in its entirety.

### BACKGROUND OF THE INVENTION

1. Field of the Invention

The present invention relates to a home network system, and more particularly to a home network system and a method for remotely installing a home service on a home gateway in each home in the home network system.

2. Description of the Related Art

The home network is a network to which information/home appliances in a home are connected. The home network realizes a so-called “digital home” that is a future home environment in which a home service can be provided at any time and place and through any device. The home network is a representative example of the digital convergence technology that can provide services such as remote education, entertainment, health care, and information/home appliance control using a variety of IT devices based on high-speed infrastructures.

The home network enables users to determine who has pressed the bell and also to determine whether or not washing has been completed while staying in their rooms. In the home network environment, the user can monitor their house using a PDA or a mobile phone from the outside, as if they control a TV using a remote controller, and can control room temperature and boil rice from the outside and also can take an automatic medical examination. A home gateway must be installed in the home of the service user to receive these home network services.

Recently, a number of home gateways have been installed in homes of service users along with commercialization of the home network services. If a user purchases a home gateway to use the home network, then a service supplier visits the home of the user and installs the home gateway in the home.

The home gateway installed in the home provides home network services to users residing in the home through communication with external environments or servers. To accomplish this, home service applications must be installed and run on the home gateway.

In current service environments, the home gateway supplier delivers home gateways to homes of users after installing service applications on the home gateways to enable them to be run on the home gateways.

In the conventional home network system, to manage the home gateway after installation, it is necessary for the service supplier to visit the home. Specifically, when there is a need to update a service application installed on the home gateway or to update a framework of the home gateway, the service supplier must visit the home to update it or alternatively perform a task for collectively updating all home gateways provided by the service supplier through a separate download server.

Therefore, there is a need to provide a system that allows home service applications to be installed on and removed from a home gateway provided in a home from a remote location and thus to allow the home gateway to be managed from a remote location without requiring that home service suppliers visit the home.

### SUMMARY OF THE INVENTION

Therefore, the present invention has been made in view of the above problems, and it is an object of the present invention to provide a home network system and a method for remotely installing and managing home services on a home gateway of a service user who desires to receive home network services.

It is another object of the present invention to provide a home network system and a remote home service installation method, wherein a system manager or a service supplier can select installation/management targets of services according to the purpose of the services from a remote location through gateway group management, scheduled task management, and the like in the home network system.

It is yet another object of the present invention to provide a home network system and a remote home service installation method, whereby services can be downloaded in real time or at a specific time to a specific home gateway provided in a home from a remote location through gateway group management, scheduled task management, and the like.

In accordance with one aspect of the present invention, the above and other objects can be accomplished by the provision of a method for installing home services in a home network system including a service distribution management system that remotely manages a plurality of home gateways installed in homes of service users and services installed on the plurality of home gateways, the method comprising performing user registration of a service user who desires to receive a service; registering a service to be provided to the service user; performing initial registration of a home gateway which a system manager has installed in a home of the service user according to the user registration; managing at least one home gateway group set by the system manager; and performing management of a task for remotely installing a service on a home gateway group that is an installation target of the service.

Preferably, the method further comprises receiving selection information of the service to be installed and the home gateway group as an installation target of the service, both of which have been selected by the system manager, and receiving an instruction to perform a task from the system manager.

In accordance with another aspect of the present invention, there is provided a home network system comprising a plurality of home gateways which are installed in homes of service users by a service manager and on which various services to be provided to the service users are installed; and a service distribution management system that remotely manages and installs the services on the plurality of home gateways, wherein the service distribution management system manages home gateway groups set by the system manager and remotely manages a task for installing a service on a home gateway group selected by the system manager.

Preferably, the service distribution management system installs the service on the selected home gateway group by a real time task or a scheduled task depending on a service installation method that the system manager has determined based on information of the home gateway group.

Preferably, the service distribution management system comprises a user registration module that registers a service user who desires to receive a service; a service registration management module that registers and manages a service to be provided to the service user; a user management module that registers a home gateway, which has been installed in a home of the service user by the system manager, according to an instruction of the system manager upon receiving an initial registration request from the home gateway, and manages information of home gateways included in an initial home gateway group that the system manager has set using home gateway information; a home gateway group management module that manages at least one home gateway group set by the system manager; a task management module that manages a task for remotely installing a service on a home gateway group that is an installation target of the service; and a storage that stores information regarding service users and services, information regarding home gateways, information regarding home gateway groups, and information regarding task management.

Preferably, the home network system further comprises a scheduled work management module that manages a scheduled task for remotely installing a service on a home gateway group, which is an installation target of the service, at a scheduled time; and a service push module that pushes an instruction to perform a task to the home gateway group, which is the installation target of the service, upon receiving the instruction to perform the task from the system manager through the task management module or the scheduled task management module.

Preferably, the home network system further comprises a task scheduler,that is called by the scheduled task management module, when a system clock set using scheduling information is generated, to instruct the service push module to start a scheduled task; and a task record management module that receives a request to retrieve a result of the task from the system manager and reports the request to the task management module or the scheduled task management module.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a home network system according to an embodiment of the present invention;

FIG. 2 is a detailed block diagram of a home network system for remotely installing home services according to an embodiment of the present invention; and

FIG. 3 is a flow chart of how home services are installed on a home gateway from a remote location in a home network system according to the embodiment of the present invention.

### DESCRIPTION OF THE PREFERRED EMBODIMENTS

Preferred embodiments of the present invention will now be described in detail with reference to the accompanying drawings. In the drawings, the same or similar elements are denoted by the same reference numerals even though they are depicted in different drawings. In the following description of the present invention, a detailed description of known functions and configurations incorporated herein will be omitted when it may obscure the subject matter of the present invention.

Recently, the application of the home network has been extended to other fields. In some cases, home network services typically provided in home environments such as home appliance control are also applied to office and industrial environments. In such environments, the service supplier or the system manager can continually support the provision and upgrade of a variety of services through direct management of home gateways without participation of their service users. The present invention provides a method for a service distribution management system remotely installing home services on home gateways included in a home gateway group using its registration, modification, inquiry, and removal functions of the home gateway group and using its scheduled task management function.

A description will be given of a method for remotely installing and managing home services in a network environment according to an embodiment of the present invention. Before the description of the method, the configuration of a home network system for installing and managing home services is described with reference to the accompanying drawings.

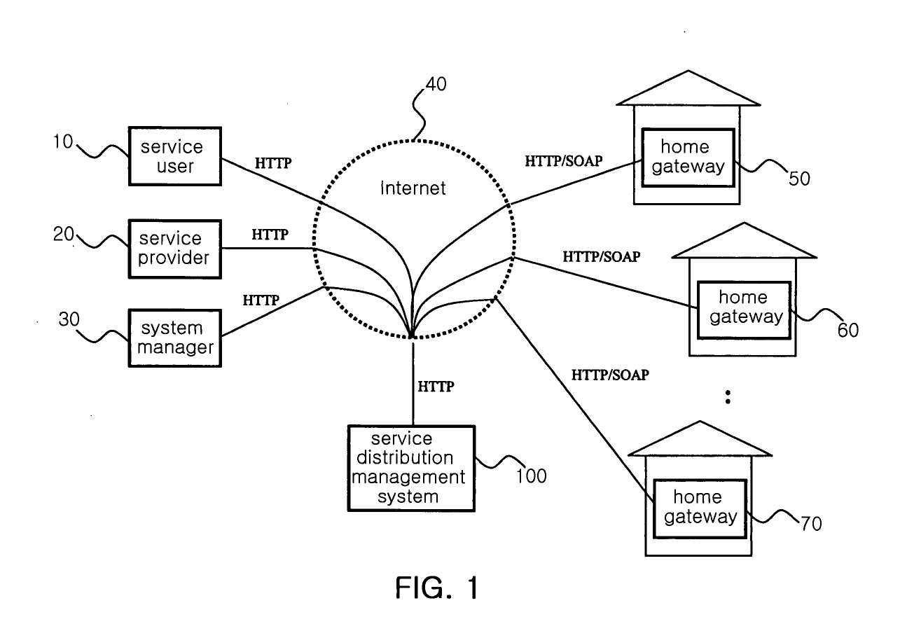

FIG. 1 is a block diagram of a home network system according to an embodiment of the present invention.

As shown in FIG. 1, the home network system includes a service user 10, a service provider 20, a system manager (or a service supplier) 30, a home gateway 50, a service distribution management system 100, and the Internet 40. The home gateway 50 allows home appliances to cooperate with external devices. The service distribution management system 100 remotely manages the home gateway 50. The Internet 40 connects the components of the home network system through the HTTP. The home gateway 50 is connected to the Internet 40 through the HTTP/SOAP.

The service distribution management system 100 remotely manages states of the home gateway 50. In response to an instruction of the service user 10 or the system manager 30, the service distribution management system 100 remotely installs (or downloads) home service applications developed by the service provider 20 on (or to) the home gateway 50 and then manages the downloaded applications. The service distribution management system 100 provides various functions to the service user 10, the service provider 20, and the system manager 30 through web user interfaces so that they can fulfill their roles in the home network environment. Main ones of the functions provided by the service distribution management system 100 are a remote home gateway management function, which is used to remotely manage the states of the home gateway 50 provided in a home, and a remote service management function, which is used to remotely install and manage home service applications on the home gateway 50. The remote service management function is provided in two modes. In one mode, the service user 10 connects to the service distribution management system 100 and requests it to install and activate home service applications, developed by the service provider 20, on the home gateway 50 of the service user 10. In the other mode, the system manager or the service supplier 30 pushes home service applications uploaded to the service distribution management system 100 to an installation target (for example, the home gateway 50) as circumstances permit. The remote service management function must be provided in this mode in industrial environments such as factories or buildings where service users 10 cannot manage the home gateway 50 by themselves.

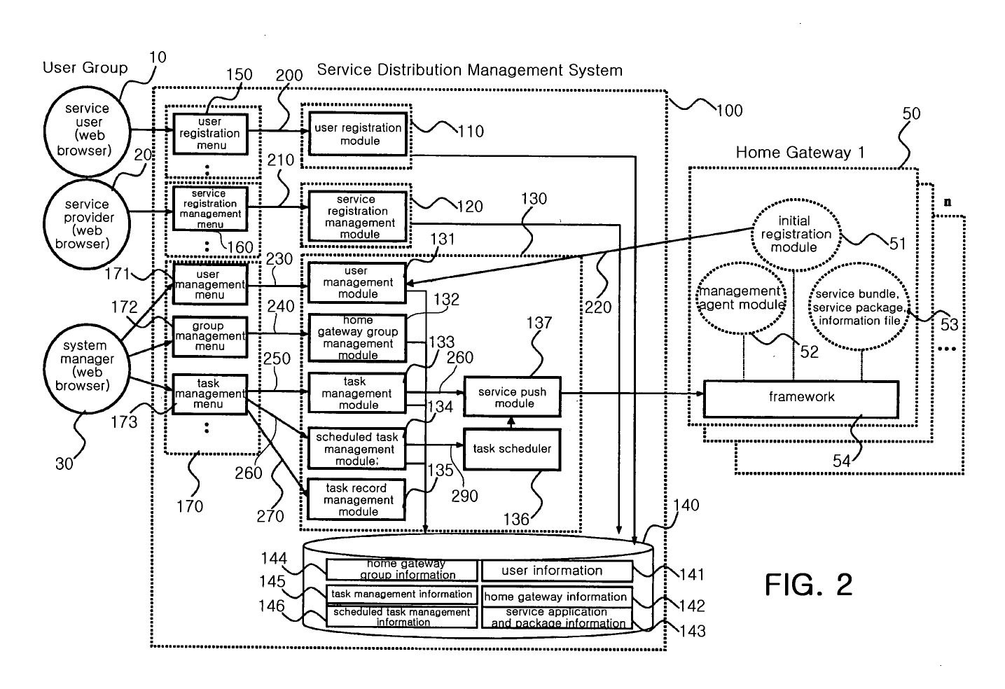

A detailed configuration of the service distribution management system 100 will now be described with reference to FIG. 2.

FIG. 2 is a detailed block diagram of a home network system for remotely installing home services according to an embodiment of the present invention.

As shown in FIG. 2, the service distribution management system 100 includes a display portion, a registration/management module portion, and a storage 140. The display portion displays registration/management menus to the service user 10, the service provider 20, and the system manager 30. The registration/management module portion performs registration and management of the service user 10, the service provider 20, and the system manager 30.

The display portion includes a user registration menu 150 for receiving a user registration request from the service user 10, a service registration management menu 160 for receiving a service registration management request from the service provider 20, and a system manager menu 170 for receiving a system management request from the system manager 30. The display portion may further include menus other than the menus 150, 160, and 170 as circumstances require. The system manager menu 170 includes a user management menu 171, a group management menu 172, and a task management menu 173.

The module portion includes a user registration module 110 that performs user registration according to a request from the service user 10, a service registration management module 120 that performs service registration management according to a request from the service provider 20, and a system management module 130 that performs system management according to a request from the system manager 30.

The user registration module 110 receives a service user registration request message 200 from the service user 10. The service user request message 200 includes service user information input through the user registration menu 150 such as a name, an address, a phone number, a social security number, an account, and a password. The user registration module 110 checks the input information and approves registration of the service user 10, and stores the input information in a corresponding region 141 in the storage 140.

The service registration management module 120 receives a service registration management request message 210 from the service provider 20. The service registration management request message 210 includes service information input through the service registration management menu 160 such as service applications, service packages, frameworks, and other service-related information to be uploaded. The service registration management module 120 then stores the input service information in a corresponding region 143 in the storage 140.

The system management module 130 includes a user management module 131, a home gateway group management module 132, a task management module 133, a scheduling management module 134, a task record management module 135, a task scheduler 136, and a service push module 137.

The user management module 131 receives an initial registration request message 220 from a home gateway 50, which the system manager 30 has installed in a home according to the service user registration and the service registration. The initial registration request message 220 includes home gateway information such as a home gateway owner and a home gateway IP address. The user management module 131 checks the home gateway information included in the initial registration request message 220 and provides the information to the system manager 30 and stores the information in a corresponding region 142 in the storage 140. The user management module 131 receives a user management request message 230 including initial home gateway group information from the system manager 30. The initial home gateway group information includes information of an initial home gateway group which the system manager 30 has set by checking the home gateway information and assigning a unique ID to the installed home gateway 50. The user management module 131 checks the received information and approves registration of the home gateway and associates the home gateway with the set home gateway group and then stores the received information in a corresponding region 144 in the storage 140.

When a new situation, which requires that a new home service such as framework upgrade and home service application download be provided to a plurality of home gateways 50 included in the initial home gateway group, has occurred, the home gateway group management module 132 receives a home gateway group management request message 240 from the system manager 30 through a group management menu 172. The home gateway group management module 132 then creates a new home gateway group according to the request and removes the previous group. The home gateway group management module 132 then inquires into the currently registered home gateway information and associates each individual home gateway 50 with the created home gateway group.

The task management module 133 performs real time task for service installation based on the association information between the home gateway group and the home gateways 50. The task management module 133 receives a real time task request command message 250, including a command to perform a real time task, from the system manager 30 through the task management menu 173 and calls the service push module 137 according to the real time task request command 250 as denoted by “260”. The command message 250 contains information regarding a home gateway group and a service application selected for installation.

The scheduling management module 134 registers scheduled task information for a scheduled task and performs a scheduled task for installing a service. The scheduled task management module 134 receives a scheduled task request command message 270, including a command to perform a scheduled task, from the system manager 30. The scheduled task request command message 270 contains information of a service application for installation and a home gateway group as an installation target of the service application, both of which have been selected by the system manager 30. The scheduled task management module 134 also receives scheduled task information, including operating time information of the task scheduler 136 such as a scheduled task date, a task start time, a task time interval, and the number of tasks, from the system manager 30 and stores the received information in a corresponding region 146 in the storage 140. Here, the information of the task time interval and the number of tasks is required to perform a task for installing a service on each target group. This information is registered since the task may fail due to power failure and temporary malfunction of the home gateway and thus the service installation task for all home gateways in the group cannot be completed with a single installation attempt.

When the system manager 30 calls the task record management module 135 to inquire into task result information through the task management menu 173, the task record management module 135 instructs the task management module 133 and the scheduled task management module 134 to retrieve and process real-time task result information and scheduled task result information.

The task scheduler 136 cooperates with the scheduled task management menu 174 and instructs the service push module 137 to start a scheduled task using a system clock.

In response to the call 260 from the task management module 133 or to the instruction received from the scheduled task management module 134 through the task scheduler 136, the service push module 137 pushes the selected service application to the selected home gateway group to allow a framework 54 in each home gateway to download and install the service application.

The storage 140 cooperates with the user registration module 110, the service registration management module 120, the user management module 131, the home gateway group management module 132, the task management module 134, and the scheduled task management module 136 to store information corresponding to each of the modules. The information stored in the storage 140 includes service user information stored in the first region 141, home gateway information stored in the second region 142, service information such as service application and package information stored in the third region 143, home gateway group information stored in the fourth region 144, task management information stored in the fifth region 145, and scheduled task management information and scheduling information stored in the sixth region 146.

Referring to FIGS. 1 and 2, at least one home gateway 50 activates downloaded service applications according to an operating environment of a framework or the like included in the home gateway and provides corresponding home services to the service user 10. Each home gateway 50 includes an initial registration module 51, a management agent module 52, a collection 53 of service bundles, service packages, information files, and the like, and a framework 54. The initial registration module 51 transmits initial registration information to the user management module 131. The framework 54 receives information from the service push module 137.

A method for remotely providing home services in the home network system according to an embodiment of the present invention will now be described with reference to the accompanying drawings. In the embodiment of the present invention, the system manager manages home gateways of its service users on a group-by-group basis and collectively installs and removes home network service applications, service packages, home gateway frameworks, information files, and the like on and from home gateways of each home gateway group.

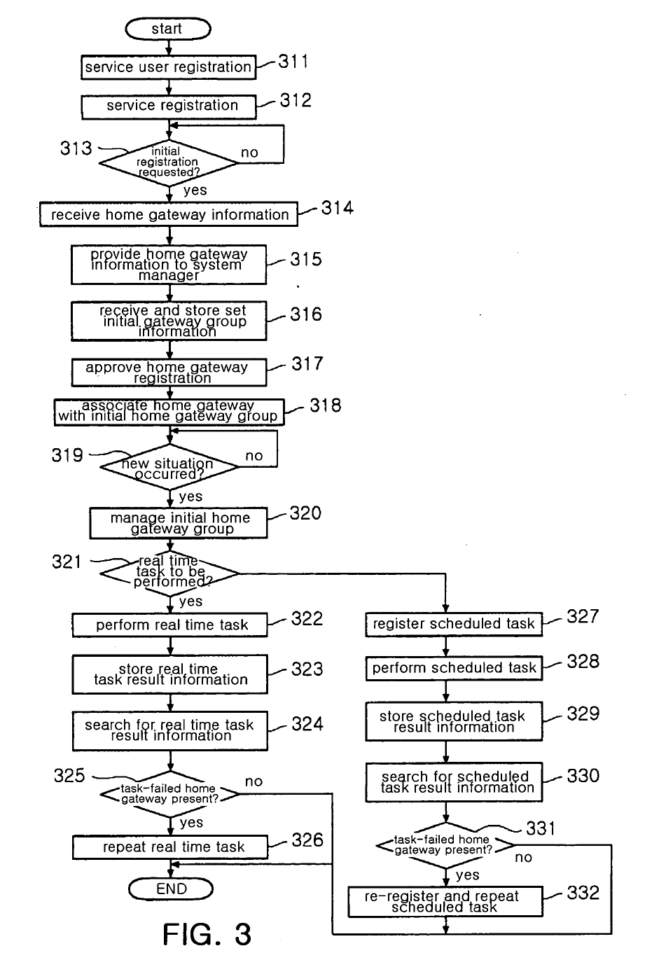

FIG. 3 is a flow chart of how home services are installed on a home gateway from a remote location in a home network system according to the embodiment of the present invention.

As shown in FIGS. 2 and 3, at step 311, the service distribution management system 100 receives service user information from a service user 10, who desires to use a home network service, through the user registration menu 150 and stores the received service user information in the corresponding region of the storage (or information repository) 140 through the user registration module 110 to perform user registration. At step 312, the service distribution management system 100 receives information of home network services to be uploaded from the service provider 20, which has developed the home network services, through the service registration management menu 160 and stores the received service information in the corresponding region 143 of the storage 140 through the service registration management module 120 to perform service registration.

The service user 10 who has registered the service user information purchases a home gateway 50 online or offline. The service supplier or the system manager 30 then visits a home of the service user 10 and installs the home gateway 50, which includes an initial registration module 51 and a framework 54 for providing a service operating environment, in the home. When the installed home gateway 50 is activated, it requests initial registration from the service distribution management system 100 through the initial registration module 51.

At step 313, the service distribution management system 100 determines whether or not initial registration has been requested. If no initial registration has been requested, the service distribution management system 100 is kept in standby mode. If initial registration has been requested, the service distribution management system 100 receives, at step 314, home gateway information such as an IP address and an owner of the home gateway 50 from the initial registration module 51 that is running on the home gateway 50. Then, at step 315, the service management module 131 in the service distribution management system 100 stores the home gateway information 220 received from the home gateway 50 in the storage 140.

At step 316, the service distribution management system 100 provides the received home gateway information to the system manager 30. The system manager 30 checks the home gateway information received through the user management module 131 and assigns a unique home gateway ID to the installed home gateway 50 to set an initial home gateway group. At step 317, the service distribution management system 100 receives information of the set initial home gateway group from the system manager 30 through the user management module 131. At step 318, the service distribution management system 100 approves registration of the installed home gateway 50 and associates the home gateway 50 with the initial home gateway group.

Thereafter, at step 319, the service distribution management system 100 determines whether or not a new situation has occurred. Examples of the new situation include a situation requiring that newly provided home service applications be downloaded and a situation requiring that the framework be updated. If no new situation has occurred, the system 100 is kept in standby mode.

If it is determined at step 319 that a new situation has occurred, it is necessary that a home service be installed on the home gateway 50 according to the initial registration and, therefore, the service distribution management system 100 performs, at step 320, home gateway group management through the home gateway group management module 132. Specifically, the service distribution management system 100 inquires into the set home gateway group information and changes the association information between the home gateway group and home gateways or creates a new home gateway group as needed and then associates the home gateway 50 with the group and performs a process for moving the home gateway information between the groups through the home gateway group management module 132.

Then, at step 321, to select a service application installation task method based on the association information between the set home gateway and home gateways, the service distribution management system 100 checks a determination that the system manager 30 has made as to whether a real time installation task or a scheduled installation task is to be performed.

If the checked result at step 321 is that the system manager 30 has determined that the real time task is to be performed, the service distribution management system 100 performs, at step 322, a real time task through the task management module 133. Specifically, the task management module 133 calls the service push module 137 to transfer a command to install the selected service application to the home gateway 50. The service installation command is sequentially transferred to the home gateways in the selected home gateway group. Then, at step 323, the service distribution management system 100 stores results of the real time task performed for each of the home gateways 50.

The system manager 30 can acquire the results of the real time task by calling the task record management module 135 through the task management menu 173. At step 324, the service distribution management system 100 retrieves task result information of the real time task from the storage 140 through the task management module 133 and reports the retrieved information to the system manager 30. The system manager 30 checks the retrieved task result information and, if the task has failed for any home gateway, it instructs the management system 100 to repeat the task for the home gateway. Then, at step 325, the service distribution management system 100 determines whether or not the task repetition instruction has been issued. If no task repetition instruction has been issued, the service distribution management system 100 determines that the task has been successfully done for all the home gateways and then terminates the task. If the task repetition instruction has been issued by the system manager 30, the service distribution management system 100 repeats, at step 326, the real time task only for home gateways 50 included in a task-failed home gateway list which the system manager 30 has created using the task result information.

On the other hand, if the checked result at step 321 is that the real time task is not to be performed, it is necessary to perform a scheduled task. Therefore, the system manager 30 selects a home gateway group as a service installation target and a service application to be installed on the group and issues a command to perform a scheduled task through the task management menu 173. The scheduled task is performed when the task scheduler 136 issues an instruction to start the scheduled task using the clock provided by the service distribution management system 100. To perform the scheduled task, the scheduled task management module 134 needs to register the operating time of the task scheduler 136. Specifically, at step 327, the service distribution management system 100 registers the scheduled task by receiving scheduled task information required to install the service on the selected home gateway group, such as an installation start time, a time period, and the number of attempts, from the system manager 30 through the task management menu 173 and storing the scheduled task information in the storage 140.

Then, when a system clock set according to the registered scheduled task information is generated, the service distribution management system 100 calls, at step 328, the scheduled task scheduler 136 to instruct the service push module 137 to perform the scheduled task, thereby transferring a command to install the selected service application to the home gateway 50. The service installation command is sequentially transferred to the home gateways in the selected home gateway group.

After performing the scheduled task, the service distribution management system 100 stores, at step 329, task result information of the scheduled task in the storage 140.

Thereafter, the system manager 30 calls the task record management module 135 through the task management menu 173 to request the module 135 to inquire into task results of the scheduled task. Upon receiving this request, the service distribution management system 100 retrieves, at step 330, task result information of the scheduled task from the storage 140 through the task management module 133 and reports the retrieved information to the system manager 30. The system manager 30 checks the retrieved task result information and, if the task has failed for any home gateway, it instructs the management system 100 to repeat the scheduled task for the home gateway through the task management menu 173. Then, at step 331, the service distribution management system 100 determines whether or not the scheduled task repetition instruction has been issued by the system manager 30. If no scheduled task repetition instruction has been received, the service distribution management system 100 determines that the scheduled task has been successfully done for all the home gateways and then terminates the scheduled task.

If the scheduled task repetition instruction has been issued, the service distribution management system 100 re-registers and repeats, at step 332, the scheduled task only for home gateways 50 included in a task-failed home gateway list which the system manager 30 has created using the task result information.

As described above, according to the present invention, the service distribution management system can remotely install home network services on home gateways using a service push method through home gateway group management and task management. In addition, network system managers and service suppliers can provide a variety of operating methods for service installation according to the purposes of deploying the home network services. Further, without participation of service users, the system can transmit desired data to a number of home gateways such as home network service applications, service packages, and home gateway frameworks, thereby providing life cycle management of the service applications that are applied not only to home network environments but also to office and factory environments.

As is apparent from the above description, the present invention provides a home network system and a remote home service installation method which have a variety of advantages. For example, a service distribution management system in the home network system collectively manages services applications on remote gateways from a remote location without participation of their service users. This reduces time and effort of the users, thereby contributing to profits of the service supplier. This also extends the application of home services that have been conventionally provided in home environments. In addition, the system manager and the service supplier can provide services flexibly according to an environment to which the system is applied.

The method according to the present invention can be implemented as a program and then be stored in a computer-readable recording medium such as a CD-ROM, a RAM, a ROM, a floppy disk, a hard disk, and a magneto-optic disc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for installing home services in a home network system including a service distribution management system that remotely manages a plurality of home gateways installed in homes of service users and services installed on the plurality of home gateways, the method comprising:
performing user registration of a service user who desires to receive a service;
registering a service to be provided to the service user;
performing initial registration of a home gateway which a system manager has installed in a home of the service user according to the user registration;
managing at least one home gateway group set by the system manager; and
performing management of a task for remotely installing a service on a home gateway group that is an installation target of the service.

2. The method according to claim 1, further comprising receiving selection information of the service to be installed and the home gateway group as an installation target of the service, both of which have been selected by the system manager, and receiving an instruction to perform a task from the system manager.

3. The method according to claim 1, wherein performing the user registration of the service user comprises:
receiving service user information from the service user;
approving the user registration by checking the received service user information; and
storing the received service user information.

4. The method according to claim 1, wherein registering the service to be provided to the service user comprises:
receiving service information from a service provider;
approving the service registration by checking the received service information; and
storing the received service information.

5. The method according to claim 1, wherein performing the initial registration of the home gateway comprises:
receiving an initial registration request from the home gateway;
receiving and storing home gateway information from the home gateway and providing the home gateway information to the system manager;
storing information of an initial home gateway group which the system manager has set using the home gateway information;
associating home gateways included in the initial home gateway group with the initial home gateway group; and
approving the initial registration request of the home gateway.

6. The method according to claim 1, wherein managing the home gateway group comprises:
retrieving stored home gateway group information when a new situation has occurred;
creating a new home gateway group using the retrieved home gateway group information; and
associating home gateways included in the new home gateway group with the new home gateway group.

7. The method according to claim 6, further comprising changing, moving, or removing items of association information between the home gateway group and the home gateways.

8. The method according to claim 1, wherein performing the task management comprises:
receiving an instruction to install a service from the system manager, when it has been determined that a real time task is to be performed based on information of a home gateway group set by the system manager and association information between the set home gateway group and home gateways included in the set home gateway group, and pushing the service to a home gateway group that is an installation target of the service; and
installing the service on each home gateway included in the home gateway group, which is the service installation target, by pushing the service to the home gateway group.

9. The method according to claim 8, further comprising storing a result of the real time task.

10. The method according to claim 9, further comprising:
receiving a request to acquire the result of the real time task from the system manager;
searching for information of the real time task result and reporting the information of the real time task result to the system manager; and
repeating the real time task for home gateways included in a task-failed home gateway list which the system manager has created using the information of the real time task result.

11. The method according to claim 1, wherein performing the task management comprises:
receiving scheduling information required to perform a scheduled task, when it has been determined that the scheduled task is to be performed based on information of a home gateway group set by the system manager and association information between the set home gateway group and home gateways included in the set home gateway group;
issuing an instruction to start the scheduled task according to a system clock set using the scheduling information; and
installing the service on each home gateway in a home gateway group, which is an installation target of the service, by pushing the service to the home gateway group according to the instruction.

12. The method according to claim 11, further comprising storing a result of the scheduled task.

13. The method according to claim 12, further comprising:
receiving a request to acquire the result of the scheduled task from the system manager;
searching for information of the scheduled task result and reporting the information of the scheduled task result to the system manager;
re-registering the scheduled task for home gateways included in a task-failed home gateway list which the system manager has created using the information of the scheduled task result; and
repeating the scheduled task for the home gateways included in the task-failed home gateway.

14. A home network system comprising:
a plurality of home gateways which are installed in homes of service users by a service manager and on which various services to be provided to the service users are installed; and
a service distribution management system that remotely manages and installs the services on the plurality of home gateways,
wherein the service distribution management system manages home gateway groups set by the system manager and remotely manages a task for installing a service on a home gateway group selected by the system manager.

15. The home network system according to claim 14, wherein the service distribution management system installs the service on the selected home gateway group by a real time task or a scheduled task depending on a service installation method that the system manager has determined based on information of the home gateway group.

16. The home network system according to claim 14, wherein the service distribution management system comprises:
a user registration module that registers a service user who desires to receive a service;
a service registration management module that registers and manages a service to be provided to the service user;
a user management module that registers a home gateway, which has been installed in a home of the service user by the system manager, according to an instruction of the system manager upon receiving an initial registration request from the home gateway, and manages information of home gateways included in an initial home gateway group that the system manager has set using home gateway information;
a home gateway group management module that manages at least one home gateway group set by the system manager;
a task management module that manages a task for remotely installing a service on a home gateway group that is an installation target of the service; and
a storage that stores information regarding service users and services, information regarding home gateways, information regarding home gateway groups, and information regarding task management.

17. The home network system according to claim 16, further comprising:
a scheduled work management module that manages a scheduled task for remotely installing a service on a home gateway group, which is an installation target of the service, at a scheduled time; and
a service push module that pushes an instruction to perform a task to the home gateway group, which is the installation target of the service, upon receiving the instruction to perform the task from the system manager through the task management module or the scheduled task management module.

18. The home network system according to claim 17, further comprising a task scheduler that is called by the scheduled task management module, when a system clock set using scheduling information is generated, to instruct the service push module to start a scheduled task.

19. The home network system according to any one of claims 16 to 18, further comprising a task record management module that receives a request to retrieve a result of the task from the system manager and reports the request to the task management module or the scheduled task management module.

20. The home network system according to claim 16, wherein the home gateway group management module manages home gateway groups by associating each of the home gateway groups with corresponding home gateways using the home gateway information and the home gateway group information set by the system manager.

21. The home network system according to claim 16, wherein, when a new situation has occurred, the home gateway group management module creates a new home gateway group using stored home gateway group information according to an instruction of the system manager and associates home gateways included in the new home gateway group with the new home gateway group and then changes, moves, or removes items of association information between the home gateway group and the home gateways.

22. The home network system according to claim 16, wherein, when the system manager has determined that a real time task is to be performed to install a service, the task management module receives an instruction to perform the real time task from the system manager, issues an instruction to perform the real time task to a home gateway group which is an installation target of the service, installs the service on each home gateway included in the home gateway group which is the service installation target, and stores a result of the real time task.

23. The home network system according to claim 22, wherein, upon receiving a request to acquire the result of the real time task from the system manager, the task management module searches for information of the real time task result and reports the information of the real time task result to the system manager and then repeats the real time task for home gateways included in a task-failed home gateway list which the system manager has created using the information of the real time task result.

24. The home network system according to claim 17, wherein, when the system manager has determined that a scheduled task is to be performed to install a service, the scheduled task management module issues an instruction to start the scheduled task according to a system clock set using stored scheduling information, installs the service on each home gateway in a home gateway group, which is an installation target of the service, and stores a result of the scheduled task.

25. The home network system according to claim 24, wherein, upon receiving a request to acquire the result of the scheduled task from the system manager, the scheduled task management module searches for information of the scheduled task result and reports the information of the scheduled task result to the system manager and then re-registers and repeats the scheduled task for home gateways included in a task-failed home gateway list which the system manager has created using the information of the scheduled task result.

26. The home network system according to claim 14, wherein each of the plurality of home gateways comprises:
an initial registration module that is installed in a home of each service user to transmit an initial registration request to the service distribution management system during initial operation; and
a framework that downloads a service upon receiving an instruction to perform a task for installing the service from the service distribution management system.
